(19) United States
(12) Patent Application Publication
(10) Pub. No.: US 2012/0064302 A1
(43) Pub. Date: Mar. 15, 2012

(54) PATTERNING METHOD

(75) Inventors: Tatsuya Shimoda, Ishikawa (JP); Yasuo Matsuki, Tokyo (JP); Ryo Kawajiri, Ishikawa (JP); Takashi Masuda, Ishikawa (JP); Toshihiko Kaneda, Ishikawa (JP)

(73) Assignee: JAPAN SCIENCE AND TECHNOLOGY AGENCY, Kawaguchi-shi (JP)

(21) Appl. No.: 13/263,805

(22) PCT Filed: Apr. 9, 2010
(86) PCT No.: PCT/JP2010/056795

§ 371 Date: Oct. 10, 2011

(30) Foreign Application Priority Data
Apr. 10, 2009 (JP) 2009-095500

(51) Int. Cl. B32B 3/30; B05D 3/12

(52) U.S. Cl. 428/172; 427/553

(57) ABSTRACT

A patterning method comprising the steps of:

the first step of disposing at least one silane compound selected from the group consisting of a silicon hydride compound and a silicon halide compound in the space between a substrate and a patterned mold; and

the second step of subjecting the silane compound to at least one treatment selected from a heat treatment and an ultraviolet exposure treatment.

A pattern composed of silicon can be formed by carrying out the second step in an inert atmosphere or a reducing atmosphere and a pattern composed of silicon oxide can be formed by carrying out at least part of the second step in an oxygen-containing atmosphere.

### TECHNICAL FIELD

The present invention relates to a patterning method.

### BACKGROUND ART

A patterned silicon film such as an amorphous silicon film, polycrystal silicon film or monocrystal silicon film is used in semiconductor devices such as integrated circuits and thin film transistors. The patterning of a silicon film is generally carried out through a process in which a silicon film is formed over the entire surface by a vapor-phase process such as CVD (Chemical Vapor Deposition) and then unwanted parts are removed by photolithography. However, this process has problems such as a bulky apparatus being required due to use of the vapor-phase process, the use efficiency of the raw material being low, the raw material being difficult to handle as it is gaseous, and a large amount of waste being produced.

Meanwhile, a silicon oxide film is often used as an electric insulating film, dielectric film and protective film for semiconductor devices. To form the silicon oxide film, there are known a vapor-phase process and a sol-gel process. Examples of the above vapor-phase process include one in which silicon is thermally oxidized in the air, plasma CVD process in which a silicon oxide film is formed from a silane gas or disilane gas in an oxidative gas such as oxygen or nitrogen oxide, and one in which a silicon oxide film is formed directly from quartz by sputtering. Examples of the above sol-gel process include one in which partially hydrolyzed sol of an alkoxysilane such as tetraethoxysilane is applied to a substrate and thermally decomposed. Out of these, the vapor-phase process has the same problems as those when the silicon film is formed. In the sold-gel process, it is difficult to obtain a fine silicon oxide film because water is produced as a reaction proceeds, a crack is apt to be produced due to the generation of internal stress in the film, and this process cannot be used for a substrate having low heat resistance, such as a plastic substrate, because the process includes the step of heating at a high temperature.

To cope with these problems, studies into a process of forming a silicon film or a silicon oxide film by a liquid-phase process are now under way. For example, JP-A 2003-313299 and WO00/59022 suggest a process of forming a silicon film or a silicon oxide film by applying a high order silane composition comprising a liquid silane compound such as cyclopentasilane, a high order silane compound obtained by photopolymerizing this liquid silane compound through exposure to ultraviolet light, and a solvent such as decalin, tetralin, methyl naphthalene, toluene, decane, octane, xylene or benzene to a substrate, removing the solvent, and heating the composition.

According to this liquid-phase process, as a bulky apparatus is not required, there is a great advantage in terms of process and cost. However, an additional step such as photolithography is still required for the formation of a pattern having a high aspect ratio. Therefore, the intricacy of the process is not completely eliminated. Further, apprehensions regarding an environmental load are not dispelled.

A nano-imprinting technology has recently been developed and attracting attention. A technology in which a several tens to several hundreds of nm uneven pattern formed on a metal mold is pressed against a resin material applied to a substrate to transfer the pattern to the resin material is disclosed in Chou, S. Y. et al., Appl. Phys. Lett., 67(21), 3114 (1995) and Chou, S. Y. et. al. , Science, 272, 85 (1996). The nano-imprinting process can be carried out in a short period of time at a low cost and has a high degree of freedom of a pattern shape that can be formed. However, although the nano-imprinting process itself is inexpensive, a metal mold which is the original form of the pattern is expensive. Further, since it is a more essential problem with this technology that the resin material which can be patterned is limited to an organic resin material such as thermoplastic resin, thermosetting resin or photocurable resin, this technology cannot be applied to the silicon film or silicon oxide film of the above semiconductor device.

A technology which is a combined technology of the above sol-gel process and the nano-imprinting technology has recently been reported. JP-A 2003-100609 discloses a technology for forming a patterned silicon oxide film by applying partial hydrolyzed sol of a hydrolysable silane compound such as alkoxysilane to a substrate, pressing a metal mold having an uneven pattern against the compound, baking and further hydrolyzing it. Since this technology is a sol-gel process, it has the defects of the above sol-gel process such as a fine silicon oxide film being hardly obtained, a crack being apt to be produced in the film, and this process being unable to be used for a plastic substrate having low heat resistance. Also, a patterned silicon film cannot be formed theoretically.

### DISCLOSURE OF THE INVENTION

It is an object of the present invention to provide a unique method which will break through the above current situation in the production process of a semiconductor device.

That is, it is an object of the present invention to provide a method of forming a patterned silicon film or silicon oxide film quickly at a low cost under mild conditions that do not require high-temperature heating by a simple process.

According to the present invention, the above object and advantage of the present invention are attained by a patterning method, comprising the steps of:

the first step of disposing at least one silane compound selected from the group consisting of a silicon hydride compound and a silicon halide compound into the space between a substrate and a patterned mold; and

the second step of subjecting the silane compound to at least one treatment selected from a heat treatment and an ultraviolet exposure treatment.

### BRIEF DESCRIPTION OF THE DRAWINGS

FIG. 1 shows optical photomicrographs of a pattern formed in Example 1;

FIG. 2 shows atomic force photomicrographs of the pattern formed in Example 1;

FIG. 3 shows an optical photomicrograph of a pattern formed in Example 2;

FIG. 4 shows scanning electron photomicrographs of a pattern formed in Example 3; and

FIG. 5 shows an optical photomicrograph of a pattern formed in Example 4.

### BEST MODE FOR CARRYING OUT THE INVENTION

The patterning method of the present invention comprises the first step of disposing at least one silane compound selected from the group consisting of a silicon hydride compound and a silicon halide compound in the space between a substrate and a patterned mold and the second step of subjecting the silane compound to at least one treatment selected from a heat treatment and an ultraviolet exposure treatment.

<Substrate>

Although the substrate used in the patterning method of the present invention is not particularly limited, for example, substrates made of quartz; glass such as borosilicate glass or soda glass; plastic; silicone resin; carbon; metal such as gold, silver, copper, silicon, nickel, titanium, aluminum or tungsten; or glass or plastic having any one of these metals, an oxide thereof or a mixed oxide on the surface may be used. An example of the above mixed oxide is a transparent conductive oxide such as ITO.

Since the patterning method of the present invention does not require high-temperature heating, it can be used for a plastic substrate having low heat resistance.

<Patterned mold>

As the patterned mold used in the patterning method of the present invention may be used molds made of the same materials as the above materials enumerated as the material constituting the substrate. Out of these, silicon, quartz, silicon with an oxide film, silicone resin and metals are preferred from the viewpoints of capability of forming a fine pattern and workability. Examples of the above silicone resin include polydimethylsiloxane (PDMS); and examples of the above metals include nickel. The pattern formed by the method of the present invention may be used as a replica of the patterned mold. When a heat treatment is carried out in the second step which will be described hereinafter, a material which can withstand heat in the heat treatment is preferred. Meanwhile, when an ultraviolet exposure treatment is carried out in the second step, a material which transmits ultraviolet light in use is preferred. To meet these requirements, the material of the patterned mold is preferably quartz or silicone resin.

Examples of the pattern of the above patterned mold include line-and-space patterns, columnar or polygonal column-like (such as square column-like) patterns, conical or polygonal pyramid-like (such as square pyramid-like) patterns, patterns having projections or holes formed by cutting these with a plane, and combinations thereof. The pattern may be a mirror surface.

According to the patterning method of the present invention, any fine pattern of the patterned mold which is a parent pattern can be reproduced. For example, a pattern having a width of not less than 10 nm, preferably not less than 50 nm and an aspect ratio of not more than 5, preferably not more than 3 can be formed. The term “aspect ratio” as used herein means a value obtained by dividing the height of each line by the width of the line or space in the line-and-space pattern, a value obtained by dividing the depth of each projection by the diameter of the projection or the length of each side in the projection pattern, or a value obtained by dividing the depth of each hole by the diameter of the hole or the length of each side in the hole pattern.

<Silane compound>

The silane compound used in the patterning method of the present invention is at least one silane compound selected from the group consisting of a silicon hydride compound and a silicon halide compound. Examples of the halogen atom of the silicon halide compound include chlorine atom, bromine atom and iodine atom. The silane compound used in the present invention preferably has substantially no Si—O bond and no Si—C bond.

Examples of the silane compound used in the patterning method of the present invention include a high order silane compound and a low order silane compound.

[High order silane compound]

The high order silane compound in the present invention is preferably a polymer compound having an element ratio represented by the following formula (1).

SiXₘ (1)

(in the above formula, X is a hydrogen atom or halogen atom, and m is an integer of 1 to 3.)
“m” is more preferably 1.5 to 2.5.

The above high order silane compound has a viscosity of preferably 0.0005 to 1,000 Pa.s, more preferably 0.001 to 10 Pa.s. The weight average molecular weight in terms of polystyrene measured by gel permeation chromatography of the high order silane compound is preferably 300 to 120,000, more preferably 1,000 to 12,000.

This high order silane compound is easy to handle, has excellent patternability and can provide a high-quality homogeneous pattern.

Although the production process of this high order silane compound is not particularly limited, this high order silane compound can be obtained by polymerizing a low order silane compound which is a precursor of the high order silane compound as a starting material as it is (neatly) or in a solution and then preferably aging it. In the present invention, the term “low order silane compound” means a compound which is polymerized to become a high order silane compound and preferably gaseous or liquid at normal temperature and normal pressure. As the low order silane compound is used a compound which is polymerized through exposure to light, exposure to an electron beam or by heating to become a high order silane compound, preferably a compound which is converted into a high order silane compound through exposure to light, that is, a compound having photopolymerizability. A high order silane compound having the above preferred properties can be easily obtained by using the above low order silane compound as a starting material and suitably adjusting polymerization conditions and conditions for aging which is optionally carried out.

The above low order silane compound having photopolymerizability is, for example, a low-molecular weight silicon hydride compound or a low-molecular weight silicon halide compound, preferably a silicon hydride compound or silicon halide compound having at least one cyclic structure in the molecule. It is more preferably at least one silicon hydride compound or silicon halide compound selected from the group consisting of compounds represented by the following formulas (2) and (3).

SiᵢX₂ᵢ (2)

SijX₂ⱼ₋₂ (3)

(in the above formulas, X is a hydrogen atom or halogen atom, i is an integer of 3 to 8, and j is an integer of 4 to 14.)

The compound represented by the above formula (2) is a silicon hydride compound or silicon halide compound having one cyclic structure in the molecule, and the compound represented by the above formula (3) is a silicon hydride compound or silicon halide compound having two cyclic structures in the molecule. The compounds represented by the above formulas (2) and (3) are preferably silicon hydride compounds in which X is a hydrogen atom.

Examples of the low order silane compound represented by the above formula (2) include cyclotrisilane, cyclotetrasilane, cyclopentasilane, cyclohexasilane and cycloheptasilane, and examples of the low order silane compound represented by the above formula (3) include bicyclo[1.1.0]butasilane, bicyclo[2.1.0]pentasilane, bicyclo[2.2.0]hexasilane, bicyclo[3.2.0]heptasilane, 1,1′-cyclobutasilylcyclopentasilane,

1,1′-cyclobutasilylcyclohexasilane,
1,1′-cyclobutasilylcycloheptasilane,
1,1′-cyclopentasilylcyclohexasilane,
1,1′-cyclopentasilylcycloheptasilane,
1,1′-cyclohexasilylcycloheptasilane,
spiro[2.2]pentasilane, spiro[3.3]heptasilane,
spiro[4.4]nonasilane, spiro[4.5]decasilane,
spiro[4.6]undecasilane, spiro[5.5]undecasilane,
spiro[5.6]dodecasilane and spiro[6.6]tridecasilane.
Compounds obtained by substituting some or all of the hydrogen atoms of these compounds by the SiH₃ group or halogen atom may also be used. “i” in the above formula (2) is preferably an integer of 3 to 7, and “j” in the above formula (3) is preferably an integer of 4 to 7. These compounds may be used alone or in combination of two or more. These low order silane compounds have such high reactivity to light that they can be photopolymerized efficiently.

The low order silane compound is preferably a compound represented by the above formula (2), particular preferably at least one selected from the group consisting of cyclotetrasilane, cyclopentasilane, cyclohexasilane and cycloheptasilane because these low order silane compounds are easily synthesized and purified, in addition to the above reason.

The above low order silane compound may contain a linear silicon hydride compound such as n-pentasilane, n-hexasilane or n-heptasilane, or a silicon hydride compound modified by a boron atom or phosphorus atom as long as its photopolymerization process by exposure to ultraviolet light is not disturbed.

The solvent which can be optionally used for the polymerization of the low order silane compound is not particularly limited but examples thereof include hydrocarbon solvents, ether solvents and polar solvents.

Examples of the above hydrocarbon solvents include n-hexane, n-heptane, n-octane, n-decane, dicyclopentane, bezene, toluene, xylene, durene, indene, tetrahydronaphthalene, decahydronaphthalene, squalane, cyclohexane, cyclooctane, cyclodecane, dicyclohexyl, tetarahydrodicyclopentadiene, perhydrofluorene, tetradecahydroanthracene, cyclopropene, cyclobutene, cyclopentene, cyclohexene, cycloheptene and cyclooctene; examples of the above ether solvents include dipropyl ether, ethylene glycol dimethyl ether, ethylene glycol diethyl ether, ethylene glycol methyl ethyl ether, diethylene glycol dimethyl ether, diethylene glycol diethyl ether, diethylene glycol methyl ethyl ether, tetrahydrofuran, tetrahydropyran, 1,2-dimethoxyethane and p-dioxane; and examples of the above polar solvents include propylene carbonate, γ-butyrolactone, N-methyl-2-pyrrolidone, dimethylformamide, acetonitrile and dimethyl sulfoxide. They may be used alone or in combination.

The ultraviolet light which is applied to the low order silane compound is preferably light having a wavelength which can polymerize the low order silane compound without fail and does not decompose a solvent when the solvent is used. The expression “wavelength which does not decompose a solvent” means a wavelength at which the chemical bond in the solvent molecule is not disconnected by exposure to ultraviolet light. The wavelength is preferably 200 to 500 nm, more preferably 254 to 420 nm. By using the ultraviolet light having this wavelength range, the low order silane compound can be polymerized without fail and impurity atoms such as carbon atom derived from the solvent can be prevented from being contained in the high order silane compound when the high order silane compound is isolated.

The irradiation intensity of the ultraviolet light is preferably 0.1 to 10,000 mW/cm², more preferably 1 to 1,000 mW/cm². The irradiation dose of the ultraviolet light is not particularly limited but preferably about 0.1 to 10,000 J/cm², more preferably about 1 to 100 J/cm². A high order silane compound having the above preferred properties can be obtained with this irradiation dose.

To isolate the high order silane compound from a solution containing the high order silane compound obtained by polymerizing the low order silane compound, the following procedure should be taken.

That is, when the high order silane compound is dissolved in the solution, it can be isolated (separated and purified) by using size exclusion chromatography (SEC), and when the high order silane compound separates out from the solution, it can be isolated by using filtration with a micro-filter. That is, the high order silane compound can be isolated from the solution containing the residual low order silane compound.

Aging which is optionally carried out after polymerization by exposure to ultraviolet light can be carried out by leaving the obtained polymer to stand at −200 to 200° C. , preferably 0 to 100° C. for preferably 360 days or less, more preferably 60 days or less. The ambient atmosphere for this aging is preferably an inert gas atmosphere. Examples of the inert gas which can be used herein include nitrogen, helium and argon. The inert gas having an oxygen concentration of not more than 1 ppm is preferably used. The high order silane compound which is most suitable for the patterning method of the present invention can be obtained through this aging step.

[Low order silane compound]

The low order silane compound in the present invention is preferably at least one selected from the compounds represented by the above formulas (2) and (3). Specific and preferred examples of these compounds are the same as those listed above. The low order silane compound may be optionally used in combination with the above linear silane compound or the above modified silane compound.

<Patterning method>

The patterning method of the present invention comprises the first step of disposing a silane compound in the space between the above substrate and the above patterned mold and the second step of subjecting the silane compound to at least one treatment selected from a heat treatment and an ultraviolet exposure treatment.

[First step]

To dispose the silane compound in the space between the substrate and the patterned mold, for example, a method in which a coating film of the silane compound is formed on the substrate, and then the patterned mold is pressed against the silane compound and a method in which the substrate and the patterned mold are opposed to each other with a space therebetween and the silane compound is injected into the space between them may be employed. Out of these, the former method is preferred because the operation is easier and the reproducibility of the pattern of the patterned mold is higher.

To form a coating film of the silane compound on the substrate, when the silane compound is a high order silane compound, a method in which the high-silane compound is disposed on the substrate as it is and a method in which the high order silane compound is dissolved in a suitable solvent, the resulting solution is applied to the substrate, and then the solvent is optionally removed to form a coating film of the high order silane compound are preferably employed.

The solvent able to be used in the method in which the high order silane compound is dissolved in the suitable solvent and the resulting solution is applied to the substrate is selected from a hydrocarbon solvent, an ether solvent and a polar solvent. Examples of the hydrocarbon solvent include n-hexane, n-heptane, n-octane, n-decane, dicyclopentane, bezene, toluene, xylene, durene, indene, tetrahydronaphthalene, decahydronaphthalene, squalane, cyclohexane cyclooctane, cyclodecane, dicyclohexyl, tetarahydrodicyclopentadiene, perhydrofluorene, tetradecahydroanthracene, cyclopropene, cyclobutene, cyclopentene, cyclohexene, cycloheptene and cyclooctene; examples of the above ether solvent include dipropyl ether, ethylene glycol dimethyl ether, ethylene glycol diethyl ether, ethylene glycol methyl ethyl ether, diethylene glycol dimethyl ether, diethylene glycol diethyl ether, diethylene glycol methyl ethyl ether, tetrahydrofuran, tetrahydropyran, 1,2-dimethoxyethane and p-dioxane; and examples of the above polar solvent include propylene carbonate, γ-butyrolactone, N-methyl-2-pyrrolidone, dimethylformamide, acetonitrile and dimethyl sulfoxide. Out of these, hydrocarbon solvents and ether solvents are preferably used from the viewpoints of the solubility of the silane compound and the stability of the obtained solution, and hydrocarbon solvents are particularly preferred.

These solvents may be used alone or in combination of two or more.

The concentration of the high order silane compound in the solution containing the high order silane compound and the above solvent is preferably 0.1 to 50 wt%, more preferably 1 to 30 wt%. Within this concentration range, the nonuniform precipitation of the high order silane compound in the above solution is prevented and high film formability is ensured, thereby making it possible to obtain a homogenous film which is uniform in thickness without fail. By suitably setting the concentration of the high order silane compound within the above range, the thickness of the formed high order silane compound film can be controlled to a desired value.

The above high order silane compound solution may further contain a dopant source and a surface tension control agent as required.

Examples of the dopant source include substances containing the group 3B element of the periodic table and substances containing the group 5B element of the periodic table. Examples of these elements include phosphorus, boron and arsenic. When the high order silane composition of the present invention contains any one of the above substances or elements, a silicon film doped with the element, that is, an n type silicon film or a p type silicon film can be obtained. Examples of the dopant source include substances numerated in JP-A 2000-31066. The content of the dopant source in the high order silane composition is suitably selected according to the finally required content of the dopant in the obtained silicon film.

As the above surface tension control agent may be used a fluorine-based, silicone-based or nonionic surfactant. By adding this surface tension control agent, the wettability of the substrate by the high order silane composition is improved and the leveling property of a liquid film formed on the substrate is improved, thereby making it possible to prevent the formation of lumps or an orange peel on the formed film without fail.

To apply the above high order silane composition to the substrate, a suitable coating technique such as spin coating, roll coating, curtain coating, dip coating, spray coating or droplet discharging method may be employed. Then, a coating film of the high order silane compound can be formed on the substrate by removing the solvent from the liquid film of the high order silane composition as required. If the solvent remains in the coating film of the high order silane compound at this point, the effect of the present invention is not diminished.

Meanwhile, to form a coating film of the silane compound on the substrate when the silane compound is a low order silane compound, a liquid low order silane compound is disposed on as it is or applied to the substrate. A modified silane compound modified by a boron atom or phosphorus atom may be used in combination with the low order silane compound. The content of the modified silane compound is suitably selected according to the finally required content of the dopant in the obtained silicon film. As for the coating technique when the low order silane compound is applied, the same techniques as those when the above high order silane compound solution is applied may be employed.

The atmosphere in the step of applying the silane compound and the step of removing the solvent which is preferably carried out after application when the silane compound is a high order silane compound is an inert gas atmosphere such as nitrogen, helium or argon, or a nonoxidizing atmosphere such as a reduced pressure state. Thereby, the modification of the high order silane compound in this stage can be prevented more surely.

The thickness of the coating film of the silane compound formed on the substrate can be suitably set according to the depth or height of the unevenness of the pattern of the patterned mold in use, for example, 0.01 to 1 μm, specifically 0.05 to 0.5 μm.

The silane compound can be disposed in the space between the substrate and the patterned mold by pressing the patterned mold against the coating film of the silane compound formed on the substrate as described above. The pressure for pressing the patterned mold is preferably 1 to 30 MPa, more preferably 1 to 10 MPa when the silane compound is a high order silane compound. When the silane compound is a low order silane compound, the pressure is preferably 0.1 to 10 MPa, more preferably 0.1 to 1 MPa.

Before the silane compound is disposed in the space between the substrate and the patterned mold, at least the patterned mold is preferably subjected to a release treatment. The release treatment may be carried out on both of the substrate and the patterned mold as required. A release agent which can be used herein is selected from a surfactant and fluorine-containing diamond-like carbon (F-DLC). The surfactant may be a known surfactant such as fluorine-based surfactant, silicone-based surfactant or nonionic surfactant.

[Second step]

The second step which is carried out after the silane compound is disposed in the space between the substrate and the patterned mold in the first step is the step of subjecting the above silane compound to at least one treatment selected from a heat treatment and an ultraviolet exposure treatment. When the silane compound is a high order silane compound, a heat treatment is preferably carried out and when the silane compound is a low order silane compound, an ultraviolet exposure treatment is preferably carried out.

The heat treatment which is carried out when the silane compound is a high order silane compound may be carried out while the high order silane compound is disposed in the space between the substrate and the patterned mold after the first step or after the patterned mold on the high order silane compound is removed.

The above heat treatment is carried out at preferably 200 to 600° C., more preferably 300 to 500° C. for preferably 10 to 240 minutes, more preferably 30 to 120 minutes. This heat treatment may be carried out in one stage or multi stages of two or more stages, or by changing the heating temperature continuously.

The wavelength of the ultraviolet light in the above ultraviolet exposure treatment is preferably 200 to 500 nm, more preferably 254 to 420 nm. The irradiation intensity of the ultraviolet light is preferably 0.1 to 10,000 mW/cm², more preferably 1 to 1,000 mW/cm². The irradiation dose of the ultraviolet light is not particularly limited but preferably 0.1 to 10,000 J/cm², more preferably 1 to 100 J/cm².

The above ultraviolet exposure treatment and the above heat treatment may be carried out at the same time.

By carrying out the second step in an inert gas atmosphere or a nonoxidizing atmosphere, the silane compound is converted into silicon having the transferred form of the unevenness of the patterned mold.

When at least part of the second step is carried out in an oxygen-containing atmosphere, preferably oxygen or air, the silane compound is converted into silicon oxide having the transferred form of the unevenness of the patterned mold.

When the second step is carried out by a heat treatment, the line width of the formed silicon oxide pattern can be adjusted by suitably controlling the ambient atmosphere. That is, since the silane compound in the present invention has the property of releasing its hydrogen atom or halogen atom at a temperature lower than 200° C. , the absorption of oxygen is promoted by supplying oxygen when the temperature of the silane compound is lower than 200° C., thereby making it possible to increase the line width of the pattern. When the temperature of the silane compound is lower than 200° C., while the heat treatment is carried out by elevating the temperature stepwise or continuously, the release of the hydrogen atom or halogen atom is promoted in an inert gas atmosphere or a nonoxidizing atmosphere, and when the temperature of the silane compound becomes higher than 200° C., supply of oxygen is started, thereby making it possible to make the line width of the pattern the same or smaller than the line width of the unevenness of the patterned mold. The relationship between the desired line width and the suitable atmosphere in the second step can be easily known through a small number of preliminary experiments conducted by a person having ordinary skill in the art.

A silicon or silicon oxide film to which the unevenness of the patterned mold has been transferred can be obtained as described above.

When the heating of the second step is carried out after the patterned mold on the silane compound has been removed, the obtained silicon or silicon oxide film may be used as it is or after it is removed from the substrate as required.

When the heating of the second step is carried out while the high order silane compound is disposed in the space between the substrate and the patterned mold, the obtained silicon or silicon oxide film is removed from the patterned mold and further removed from the substrate as required before use.

In either case, before or after the film is removed from the substrate or from the substrate and the patterned mold, a heat treatment maybe further carried out optionally. This optional heat treatment is carried out at preferably 200 to 600° C., more preferably 300 to 500° C. for preferably 10 to 240 minutes, more preferably 30 to 120 minutes.

<Silicon film or silicon oxide film>

The pattern of the silicon film formed by the method of the present invention as described above is composed of high-purity silicon containing substantially no impurities and shows high semiconducting properties. As for the contents of impurities in the silicon film formed by the method of the present invention, the carbon content can be set to not more than 1×10²² atoms/cm³, preferably not more than 1×10²¹ atoms/cm³, the oxygen content can be set to not more than 1×10²¹ atoms/cm³, preferably not more than 1×10²⁰ atoms/cm³, and the hydrogen content can be set to not more than 1×10²³ atoms/cm³, preferably not more than 1×10²² atoms/cm³.

The pattern of the silicon oxide film formed by the method of the present invention is composed of high-purity silicon oxide containing substantially no impurities and shows high insulation properties. As for the contents of impurities in the silicon oxide film formed by the method of the present invention, the carbon content can be set to not more than 1×10¹⁹ atoms/cm³, preferably below the detection limit of secondary ion mass spectrometry (SIMS).

The pattern of the silicon oxide film formed by the method of the present invention is a very fine film having high homogeneity and shows a high breakdown voltage as compared with a silicon oxide film formed by the known sol-gel process. For example, in the case of a 0.2 μm-thick silicon oxide film, its breakdown voltage can be set to not less than 6 MV/cm, more specifically not less than 7 MV/cm.

<Semiconductor device, optical device or display device>

The semiconductor device, optical device or display device of the present invention has the pattern obtained as described above. Examples of the above semiconductor device include solar cells, transistors, light emitting diodes, memories, IC's, LSI's and CPU's.

### Examples

The following operation was carried out in nitrogen having an oxygen content of not more than 1 ppm unless stated otherwise.

The weight average molecular weights of high order silane compounds in the following Synthesis Examples and silicone resin in Comparative Example are values in terms of polystyrene obtained from data of gel permeation chromatography (GPC) measured under the following conditions by using the following measuring instrument.

The viscosity of the high order silane composition is a value measured by using the following measuring instrument.

<weight average molecular weight>

Measuring instrument: 1200 Series of Agilent Technologies Column: Packed Column for HPLC KF-G and Packed Column for HPLC K-805L of Showa Denko K.K. were connected in series. Solvent: Cyclohexene was used for the measurement of a high order silane compound and toluene was used for the measurement of silicone resin.
Standard sample: monodisperse polystyrene (TSK standard POLYSTYRENE of Tosoh Corporation)

<viscosity>

Measuring instrument: BISCOMATE VM-10A-L of CBC Co., Ltd.

Cyclopentasilane which was synthesized as disclosed by JP-A 2001-262058 and a solvent purified by distillation were used.

Nano-imprinting experiments were conducted by using the UV nano-imprinting experimental kit of Toyo Gosei Co., Ltd. in Examples 1, 2 and 5 and a nano-imprinting experimental apparatus having a press (test model) in Examples 3 and 4.

The UV nano-imprinting experimental kit of Toyo Gosei Co., Ltd. is mainly composed of a pedestal, a mold holder and a press weight. A transfer substrate was placed on the pedestal to forma coating film of a sample on the substrate, a mold is fixed in the mold holder and pressed against the transfer substrate by using the press weight, and then a heat treatment or an ultraviolet exposure treatment is carried out to transfer the mold.

The nano-imprinting experimental apparatus having a press is mainly composed of a pedestal, a mold holder and two press metal plates. Both of the two press metal plates have a heater and a temperature regulator so that the pedestal and the mold holder sandwiched between them can be heated up to 200° C. The two press metal plates can press the pedestal and the mold holder sandwiched therebetween by the principle of leverage, and the pressure can be known by a load cell.

<Production of replica mold>

### Production Example 1

PH-350 of NTT-AT Nano-Fabrication Corporation (trade name, a nano-imprinting test mold having a plurality of line-and-space patterns with a line width of 0.35 to 3 μm, a plurality of columnar projections with a diameter of 0.5 to 10 μm and a plurality of square patterns having a side length of 0.5 to 10 μm) was used as a parent mold. The Durasurf HD-1100 precision mold release agent of Daikin Chemicals Sales Ltd. was applied to this parent mold by spin coating and heated at 60° C. for 5 minutes to make a release treatment on the mold before use.

A glass substrate was prepared and subjected to a release treatment like the above parent mold.

SYLGARD 184 SILICONE ELASTOMER BASE (agent A) and SYLGARD 184 SILICONE ELASTOMER CURING AGENT (agent B) which constitute a two-liquid curable polydimethylsiloxane (PDMS) manufactured by Dow Corning Toray Co., Ltd. were mixed together in a weight ratio of 10:1 at room temperature in the atmosphere. This mixture was dropped on the above parent mold, and the glass substrate was pressed against this mixture from above and heated at 100° C. for 45 minutes in this state to cure PDMS.

After heating, PDMS was left to be cooled to room temperature, removed gently by tweezers and fixed on a quartz substrate with a pressure-sensitive adhesive double coated tape to obtain a replica mold.

<Synthesis of high order silane compound>

### Synthesis Example 1

While cyclopentasilane was stirred in the absence of a solvent, 25 mW/cm² of ultraviolet light including a bright line having a wavelength of 390 nm was applied to cyclopentasilane for 1 hour to photopolymerize it so as to obtain a high order silane compound. The obtained high order silane compound was dissolved in cyclooctane to prepare a high order silane composition which is a cyclooctane solution containing 10 wt% of the high order silane compound. The high order silane compound contained in this high order silane composition had a weight average molecular weight of 10,000 and a viscosity of 100 mPa.s.

<Nano-imprinting experimental examples>

### Example 1

The Durasurf HD-1100 was applied to the replica mold obtained in the above Production Example 1 by spin coating and heated at 60° C. for 5 minutes to make a release treatment on the mold.

A silicon wafer was used as the transfer substrate. The high order silane composition obtained in the above Synthesis Example 1 was applied to the surface of this silicon wafer by spin coating to form a 0.2 μm-thick coating film of the high order silane compound.

The silicon wafer having this coating film was set in the experimental kit, and the replica mold which had been subjected to the above release treatment was pressed against the coating film. Then, the whole experimental kit was heated at 200° C. for 10 minutes. After the experimental kit was left to be cooled, the transfer substrate was taken out from the kit, the replica mold was removed, and then the silicon wafer was heated at 300° C. for 30 minutes to obtain a pattern having an interference fringe which was a transferred pattern from the replica mold.

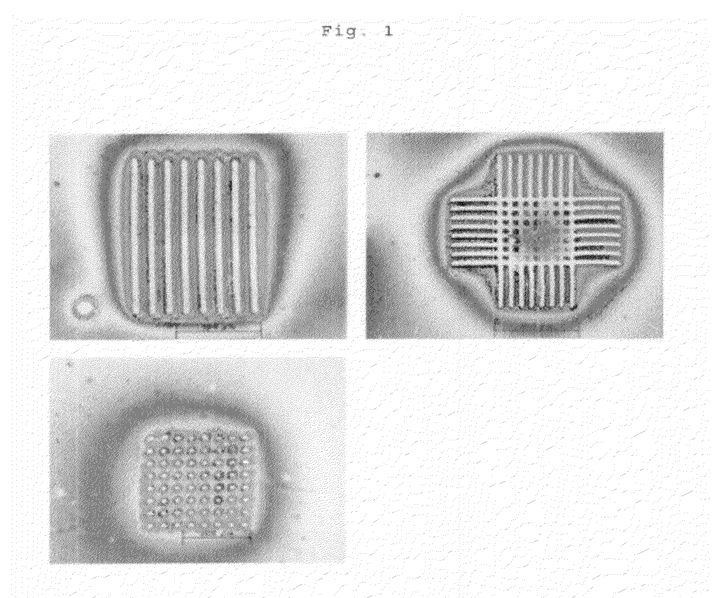

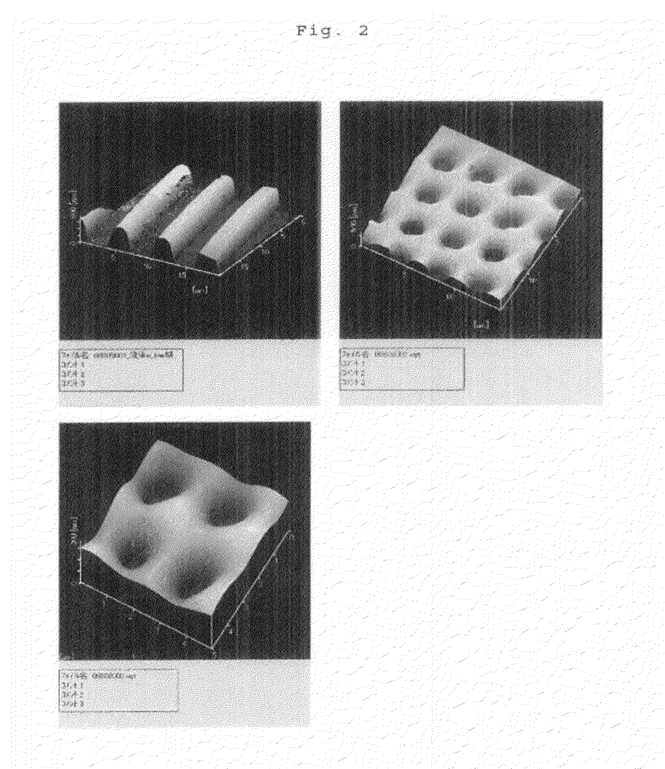

When the above pattern was observed through an optical microscope and an atomic force microscope, satisfactory transfer was confirmed. Three optical photomicrographs and three atomic force photomicrographs are shown in FIG. 1 and FIG. 2, respectively. It is confirmed from these photomicrographs that a line-and-space pattern having a line width of 3 μm and a height of 650 nm, holes having a diameter of 3 μm and a depth of 400 nm and holes having a diameter of 2 μm and a depth of 250 nm were transferred well.

When the above pattern was analyzed by X-ray photoelectron spectrometry (XPS), a peak attributed to the 2p orbital energy of silicon was seen at 99 eV. Therefore, it was found that this pattern was composed of silicon. When impurity analysis was made on a flat film area other than the uneven area of this pattern by SIMS, the carbon content was 1×10²⁰ atoms/cm³, the oxygen content was 1×10¹⁹ atoms/cm³, and the hydrogen content was 6×10²¹ atoms/cm³.

When the brightness conductivity of the flat area of the above pattern was measured by using an artificial sunlight lamp (Solar MiniUSS-40 of Ushio Inc.), it was 1×10⁻⁵ S/cm in a bright state and 3×10⁻¹¹ S/cm in a dark state.

### Example 2

The Durasurf HD-1100 was applied to the replica mold obtained in the above Production Example 1 by spin coating and heated at 60° C. for 5 minutes to make a release treatment on the mold.

A quarts substrate was used as the transfer substrate, and cyclopentasilane was dropped on the surface of this substrate. The silicon wafer having this cyclopentasilane was set in the experimental kit, and 10 mW/cm² of ultraviolet light including a bright line having a wavelength of 365 nm was applied to cyclopentasilane with a UV penlight which was provided in the experimental kit for 5 minutes while the replica mold which had been subjected to the above release treatment was pressed against cyclopentasilane to photopolymerize cyclopentasilane. Then, the whole experimental kit was heated at 200° C. for 30 minutes. After the experimental kit was left to be cooled, the transfer substrate was taken out from the kit, and the replica mold was removed to obtain a pattern having an interference fringe which was a transferred pattern from the replica mold.

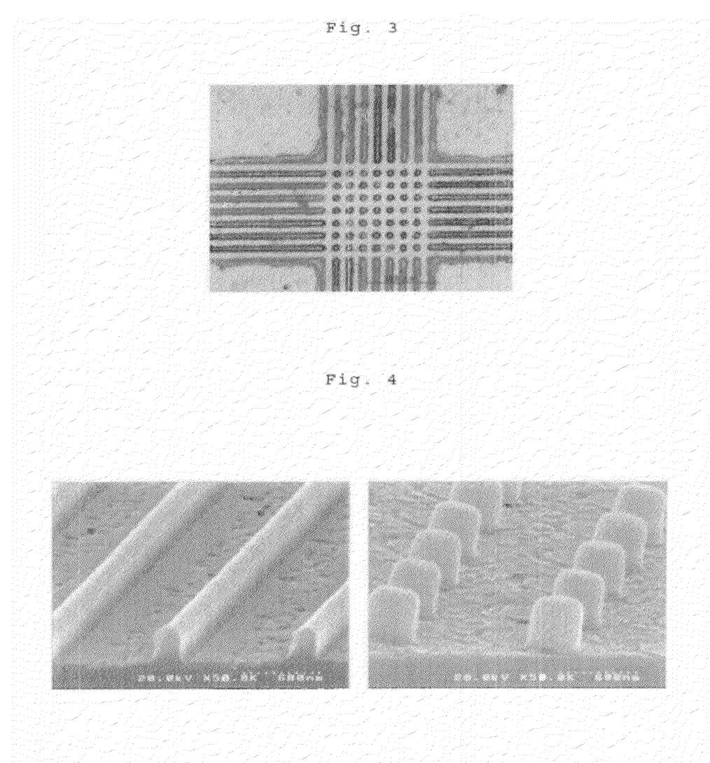

When the above pattern was observed through an optical microscope, the good transfer of the pattern was confirmed. An optical photomicrograph of this pattern is shown in FIG. 3. It was confirmed from this photomicrograph that a line-and-space pattern having a minimum line width of 4 μm and a height of 500 nm and a square pattern having 4 μm squares were transferred well.

When the above pattern was analyzed by XPS, a peak attributed to the 2p orbital energy of silicon was seen at 99 eV. Therefore, it was found that this pattern was composed of silicon. When impurity analysis was made on a flat film area other than the uneven area of this pattern by SIMS, the carbon content was 3×10²⁰ atoms/cm³, the oxygen content was 5×10¹⁹ atoms/cm³, and the hydrogen content was 5×10²¹ atoms/cm³.

When the brightness conductivity of the flat area of the above pattern was measured in the same manner as in Example 1, it was 1×10⁻⁵ S/cm in a bright state and 2×10⁻¹¹ S/cm in a dark state.

### Example 3

The Durasurf HD-1100 was applied to a TEOS processed substrate mold which is a mold for nano-imprinting experiments having a plurality of line-and-space patterns with a line width of 0.1 to 10 μm and a plurality of hole patterns with a diameter of 0.1 to 10 μm by spin coating and heated at 60° C. for 5 minutes to make a release treatment on the mold.

A silicon wafer was used as the transfer substrate, and the high order silane composition obtained in the above Synthesis Example 1 was applied to the surface of this wafer by spin coating to form a 0.2 μm-thick coating film of the high order silane compound.

The silicon wafer having this coating film was set in the nano-imprinting experimental apparatus having a press and heated at 170° C. for 60 minutes while the TEOS processed substrate mold was pressed against the coating film at a pressure of 1×10⁷ N/m². After the experimental apparatus was left to be cooled, pressure was removed, the silicon wafer having the coating film after pressurization and heating and the TESO processed substrate mold were taken out, and the coating film was heated on a hot plate at 300° C. for 30 minutes while the TEOS processed substrate mold was mounted on the coating film. Thereafter, the TEOS processed substrate mold was removed gently to obtain a pattern having an interference fringe which was a transferred pattern from the TEOS processed substrate mold.

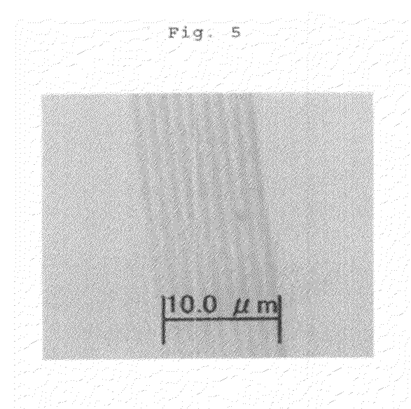

When the above pattern was observed through a scanning electron microscope, the good transfer of the pattern was confirmed. Two scanning electron photomicrographs of this pattern are shown in FIG. 4. It was confirmed from these photomicrographs that a line-and-space pattern having a line width of 0.2 μm and a height of 300 nm and dots having a diameter of 0.4 μm and a height of 0.5 nm were transferred well.

When the above pattern was analyzed by XPS, a peak attributed to the 2p orbital energy of silicon was seen at 99 eV. Therefore, it was found that this pattern was composed of silicon. When impurity analysis was made on a flat film area other than the uneven area of this pattern by SIMS, the carbon content was 2×10¹⁹ atoms/cm³, the oxygen content was 8×10¹⁸ atoms/cm³, and the hydrogen content was 4×10²¹ atoms/cm³.

When the brightness conductivity of the flat area of the above pattern was measured in the same manner as in Example 1, it was 2×10⁻⁵ S/cm in a bright state and 3×10⁻¹¹ S/cm in a dark state.

### Example 4

A TEOS processed substrate mold which was similar to that used in Example 3 and (heptadecafluoro-1,1,2,2-tetrahydrodecyl) triethoxysilane (commercially available product manufactured by Gelest, Inc.) were encapsulated into a closed container and heated at 120° C. for 2 hours. Thereafter, the TEOS processed substrate was taken out from the container, washed ultrasonically in a toluene solvent for 10 minutes and heated at 80° C. for 10 minutes to make a release treatment on the TEOS processed substrate.

A silicon wafer was used as the transfer substrate, and a cyclooctane solution of the high order silane compound obtained in the above Synthesis Example 1 was applied to the surface of the wafer by spin coating to form a 0.2 μm-thick coating film of the high order silane compound. The substrate having this coating film was further heated at 50° C. for 10 minutes.

The silicon wafer having this coating film was set in the nano-imprinting experimental apparatus having a press, and a pressure treatment was carried out at room temperature for 10 minutes while the TEOS processed substrate mold which had been subjected to the above release treatment was pressed against the coating film at a pressure of 1×10⁷ N/m². After pressure was removed, the silicon wafer having the coating film and the TEOS processed substrate mold after pressurization were taken out from the experimental apparatus, and the coating film was heated on a hot plate at 400° C. for 30 minutes while the TEOS processed substrate mold was mounted on the coating film. Thereafter, the TEOS processed substrate mold was removed gently to obtain a pattern having an interference fringe which was a transferred pattern from the TEOS processed substrate mold.

When the above pattern was observed through an optical microscope, the good transfer of the pattern was confirmed. An optical photomicrograph of this pattern is shown in FIG. 5. It was confirmed from the photomicrograph that a line-and-space pattern having a line width of 1 μm was transferred well.

When the above pattern was analyzed by XPS, a peak attributed to the 2p orbital energy of silicon was seen at 99 eV. Therefore, it was found that this pattern was composed of silicon. When impurity analysis was made on a flat film area other than the uneven area of this pattern by SIMS, the carbon content was 8×10¹⁹ atoms/cm³, the oxygen content was 2×10¹⁹ atoms/cm³, and the hydrogen content was 5×10²¹ atoms/cm³.

When the brightness conductivity of the flat area of the above pattern was measured in the same manner as in Example 1, it was 2×10 ⁵ S/cm in a bright state and 5×10⁻¹¹ S/cm in a dark state.

### Example 5

The Durasurf HD-1100 was applied to the replica mold obtained in the above Production Example 1 by spin coating and heated at 60° C. for 5 minutes to make a release treatment on the mold.

A silicon wafer was used as the transfer substrate, and a cyclooctane solution of the high order silane compound obtained in the above Synthesis Example 1 was applied to the surface of the wafer by spin coating to form a 0.2 μm-thick coating film of the high order silane compound.

The replica mold which had been subjected to the above release treatment was pressed against this coating film. Then, the whole experimental kit was heated at 200° C. for 10 minutes. After the experimental kit was left to be cooled, the transfer substrate was taken out from the kit, the replica mold was removed, and the silicon wafer was heated on a hot plate at 200° C. for 30 minutes and further at 400° C. for 30 minutes in the air to obtain a pattern having an interference fringe which was a transferred pattern from the replica mold.

When the above pattern was observed through an optical microscope, the good transfer of the pattern was confirmed.

When the above pattern was analyzed by X-ray photoelectron spectrometry (XPS), a peak attributed to the 2p orbital energy of silicon was seen at 103 eV. Therefore, it was found that this pattern was composed of silicon oxide. It was further confirmed from the analysis of the depth direction by SIMS that a homogeneous silicon oxide film was formed. This silicon oxide film contained Si and O in an atomic ratio of 33:67, and its carbon content was below the detection limit.

The resistivity of the above pattern was 1×10¹³ Q cm. When I—V measurement was made on the above pattern, it was confirmed that it retained high insulation properties without causing breakdown even at 8 MV/cm.

### Comparative Example 1

60.9 g of methyl trimethoxysilane, 177.3 g of tetramethoxysilane and 599.1 g of n-butyl ether were fed to a quartz flask whose inside had been substituted by nitrogen. After this flask was heated at 60° C. in a water bath, 2.3 g of a 20 wt% oxalic acid aqueous solution and 160.4 g of ultra pure water were added to carry out a reaction at 60° C. for 5 hours under agitation. The reaction mixture was concentrated under a reduced pressure until the amount of the liquid became 500 g so as to obtain an n-butyl ether solution containing 20 wt% of silicone resin which is a co-hydrolyzed and condensed product of the raw material compound. N-butyl ether was further added to this solution to dilute it until the concentration of the silicone resin became 10 wt% so as to obtain a composition for forming a silicone film. The weight average molecular weight in terms of polystyrene measured by GPC of the silicone resin contained in this composition was 3,600.

The above composition for forming a silicone film was applied to an 8-inch silicon wafer by spin coating and heated at 80° C. for 5 minutes in the air, at 200° C. for 5 minutes in nitrogen and then at 425° C. for 1 hour in vacuum to obtain an achromatic transparent glassy film.

When the composition of the obtained film was analyzed by XPS, it was found that this film contained Si, O and C in an atomic ratio of 30:45:25. This film had a resistivity of 8×10¹⁰ Ωm. When IV measurement was made on the obtained film, breakdown occurred at 5 MV/cm.

### Effect of the Invention

According to the present invention, there is provided a method of forming a patterned silicon film or silicon oxide film under mild conditions easily and quickly at a low cost. The silicon film or silicon oxide film is a pattern of silicon or silicon oxide having unevenness which mates with the unevenness of a patterned mold, preferably a transferred pattern.

According to the method of the present invention, since patterned unevenness is formed when the precursor turns into silicon or silicon oxide, the formed pattern can be used directly without being subjected to an additional step such as photolithography or chemical mechanical polishing.

The pattern formed by the method of the present invention can be advantageously used as a silicon film or silicon oxide film for use in semiconductor devices, optical devices and display devices, or a replica mold used in nano-imprinting technology.

1. A patterning method comprising the steps of:
the first step of disposing at least one silane compound selected from the group consisting of a silicon hydride compound and a silicon halide compound in the space between a substrate and a patterned mold; and
the second step of subjecting the silane compound to at least one treatment selected from a heat treatment and an ultraviolet exposure treatment, wherein
the first step is carried out by forming a coating film of the silane compound on the substrate and pressing the patterned mold against the coated film.

2. The patterning method according to claim 1, wherein the silane compound is a high order silane compound and the treatment in the second step is a heat treatment.

3. The patterning method according to claim 2, wherein the high order silane compound is obtained by applying ultraviolet light to at least one compound selected from the group consisting of compounds represented by the following formulas (2) and (3).
SiᵢX₂ᵢ (2)
SiⱼX₂ⱼ₋₂ (3)
(in the above formulas, X is a hydrogen atom or halogen atom, i is an integer of 3 to 8, and j is an integer of 4 to 14.)

4. The patterning method according to claim 3, wherein the viscosity of the high order silane compound is 0.0005 to 1,000 Pa.s.

5. The patterning method according to claim 2, wherein the heat treatment in the second step is carried out while the high order silane compound is disposed in the space between the substrate and the patterned mold.

6. The patterning method according to claim 2, wherein the heat treatment in the second step is carried out while the patterned mold on the high order silane compound is removed.

7. The patterning method according to claim 1, wherein the silane compound is at least one compound selected from the group consisting of the compounds represented by the above formulas (2) and (3), and the treatment in the second step is the ultraviolet exposure treatment.

8. (canceled)

9. The patterning method according to any one of claims 1 to 7, wherein the second step is carried out in an inert atmosphere or reducing atmosphere, and the formed pattern is composed of silicon.

10. The patterning method according to any one of claims 1 to 7, wherein at least part of the second step is carried out in an oxygen-containing atmosphere, and the formed pattern is composed of silicon oxide.

11. A pattern formed by the method of claim 10.

12. A semiconductor device, optical device or display device having the pattern of claim 11.
